(19) United States
(12) Patent Application Publication
(10) Pub. No.: US 2026/0287776 A1
(43) Pub. Date: Sep. 24, 2026

(54) METHOD FOR CEMENT BOND EVALUATION

(71) Applicant: Halliburton Energy Services, Inc., Houston, TX (US)

(72) Inventors: Jian Hua Zhu, Singapore (SG); Clovis Bonavides, Houston, TX (US); Li Gao, Houston, TX (US); Batakrishna Mandal, Houston, TX (US); Amit Padhi, Houston, TX (US)

(73) Assignee: Halliburton Energy Services, Inc., Houston, TX (US)

(21) Appl. No.: 19/384,918

(22) Filed: Nov. 10, 2025

Related U.S. Application Data
(60) Provisional application No. 63/776,701, filed on Mar. 24, 2025.

(51) Int. Cl. G01V 1/50; E21B 47/005

(52) U.S. Cl. CPC G01V 1/50; E21B 47/005; E21B 2200/20; G01V 2210/6226

(57) ABSTRACT

A method may comprise disposing an acoustic logging tool into a wellbore, wherein the acoustic logging tool comprises a P-E transceiver. The method may further comprise transmitting one or more acoustic waves from the acoustic logging tool with the P-E transceiver, recording superimposition of first reflection and subsequent reverberations at the acoustic logging tool with the P-E transceiver, and creating acoustic waveforms. The method may further comprise identifying one or more model parameters of the wellbore and deriving a predicted impedance from the one or more model parameters of the wellbore and the acoustic waveform.

### BACKGROUND

For oil and gas exploration and production, a network of wells, installations and other conduits may be established by connecting sections of metal pipe together. For example, a well installation may be completed, in part, by lowering multiple sections of metal pipe (i.e., a conduit string) into a wellbore, and cementing the conduit string in place. A string of steel pipes is installed inside the borehole to support the wellbore from collapsing and isolate different formation zones to prevent zonal contamination such as connection between aquifers and hydrocarbon zones. Cement is pumped into the annulus space between casing and wellbore wall to bond the casing to formation which provides structural support to casing and prevents fluid migration between formations.

Poorly bonded casing-cement interface may potentially reduce production efficiency, create pathways for fluid migration, affect well structural integrity and cause environmental damage with uncontrolled fluid flow. Thus, it is crucial to have knowledge on the quality of bond between casing, cement and formation. This cement bond knowledge is used to satisfy mandatory regulatory requirements as well as to establish a plan for re-work should such work becomes necessary. One technique widely used to assess cement bond quality is the ultrasonic pulse echo technique with which the acoustic impedance of an annulus behind casing is measured, based on which cement-casing bonding condition is inferred.

In pulse echo application for cement bond evaluation, an ultrasonic transceiver first works in pulse mode to transmit ultrasonic pulses which travel through the wellbore fluid and impinges upon well casing. The transceiver then operates in receiving mode to capture acoustic signals echoing back from well casing. Typically, the echo signal consists of two components: a first echo caused by the strong casing wall reflection due to large acoustic Impedance contrast between wellbore fluid and casing, followed by casing reverberations as the ultrasonic wave is bounced back and forth between the inner casing wall and the outer casing wall. At each bounce, part of the wave energy is leaking into cement/formation, resulting in the time decay of this signal. Then, acoustic impedance of the material behind casing, be it cement, drilling fluid, reservoir fluid or formation, may be derived by comparing received signals between the first echo and subsequent reverberations.

However, there may be challenges to determining acoustic impedance of annulus materials based on the measured pulse-echo data obtained in a downhole logging operation. These may comprise oversimplification as a one-dimensional plane wave propagation, low signal to noise ratio (SNR), and additional factors affecting impedance. First, in order to meet the need for real time operation, typically the acoustic wave is simplified as one-dimensional plane wave propagation which ignores important factors such as ultrasonic beam spreading, beam diffraction, and variations in the distance between transceiver and casing wall which is dependent on the inner diameter of casing. Second, in situations where the wellbore fluid is highly attenuative such as in high viscous oil-based drilling fluid, the received signal level has low signal-to-noise ratio (SNR), which further complicates impedance calculation. Third, all the factors comprising transducer firing pulse signature, the size of casing (curvature), and casing thickness all influence the resulted acoustic waveform captured by the transceiver. Unless all these factors are properly accounted for in the process of calculating annulus acoustic impedance from received pulse-echo signal, one may obtain inaccurate annulus acoustic impedance values, hence draw erroneous conclusion on cement-casing bonding condition. Given the importance of knowing the true cement bonding conditions, erroneous cement bond interpretations may have substantial regulatory, environmental and economic repercussions.

### BRIEF DESCRIPTION OF THE DRAWINGS

These drawings illustrate certain aspects of some examples of the present disclosure and should not be used to limit or define the disclosure.

FIG. 1 illustrates a system including an acoustic logging tool;

FIG. 2 illustrates an example information handling system;

FIG. 3 illustrates another example information handling system;

FIG. 4 is a schematic showing potential ray paths of energy from cement-formation interface according to some embodiments of the present disclosure;

FIG. 5 illustrates the physics phenomenon that an acoustic wave and echo may experience during the pulse-echo measurement operations;

FIG. 6 is a graph that shows an example of directly using three-layer model to predict annulus impedance;

FIG. 7 is a workflow that may be utilized to predict annulus impedance;

FIG. 8 is a graph showing the segmentation of a typical measured pulse-echo response into source pulse, delay and casing reverberation.

FIG. 9A is a graph illustrating the linear correlation established between ten attributes and ten impedances;

FIG. 9B is a graph that may be utilized to establish a correlation casing thickness, attribute(s) from synthetic waveforms, and annulus impedance;

FIG. 10 is a workflow for the process of calculating an SER attribute;

FIG. 11 is workflow for extracting a source pulse from a measured waveform using 1D model;

FIG. 12 is a graph that illustrates some recovered echoes, acquired at different depths from the recoded data, that show no significant oscillations originated from energy bouncing within the casing;

FIG. 13 is a workflow for deriving corrected attribute from an initial attribute;

FIG. 14 is a graph of the spectrum amplitudes of first reflection from a flat plate with different distances between P-E transceiver and flat plate (standoff) at normal incidence;

FIG. 15 is a graph that shows the computed initial impedance from test with different standoff values, before and after standoff correction; and

FIG. 16 shows predicted annulus impedance for waveforms acquired from lab experiments over twenty-four different testing parameter configurations with multiple fluids inside casing, multiple thicknesses of casing and multiple sizes of casing.

### DETAILED DESCRIPTION

Methods and systems herein may generally relate to improvements in correcting and/or accounting for comprise oversimplification as a one-dimensional plane wave propagation, low signal to noise ratio (SNR), and additional factors affecting impedance. For example, a new signal attribute (spectral energy ratio) may be measured for annulus acoustic impedance. In addition, methods and systems may comprise new improvements to determine clean first echo according to downhole measured waveforms. Through theoretical and experimental analyses, all the aforementioned factors are systematically taken into consideration. This combination results in an improved impedance calculation accuracy and precision, especially under challenging logging conditions. This results in improved cement bonding analysis which has many real-world advantages as described above.

Systems and methods herein may comprise improvements to extract source pulse with consideration on amplitude difference between 1D model and 3D real situation. Further, a new method to obtain transducer source pulse from downhole logging and a new attribute for impedance inversion that focuses on single frequency independent of drilling fluid acoustic attenuation. In addition, a correction on amplitude changes during propagation to remove impact of propagation distance and correction on the effect of curvature to remedy the impact of casing curvature. These may all comprise a new calibration scheme. Methods and systems described herein may introduce a solution to measure annulus impedance behand casing based upon 1D model compensated for high-dimensional waveform propagation effects such as propagating distance and casing curvature. In examples, methods and systems may be intrinsically independent of mud attenuation. Hence it provides more accurate and reliable annulus impedance measurement than existing solutions.

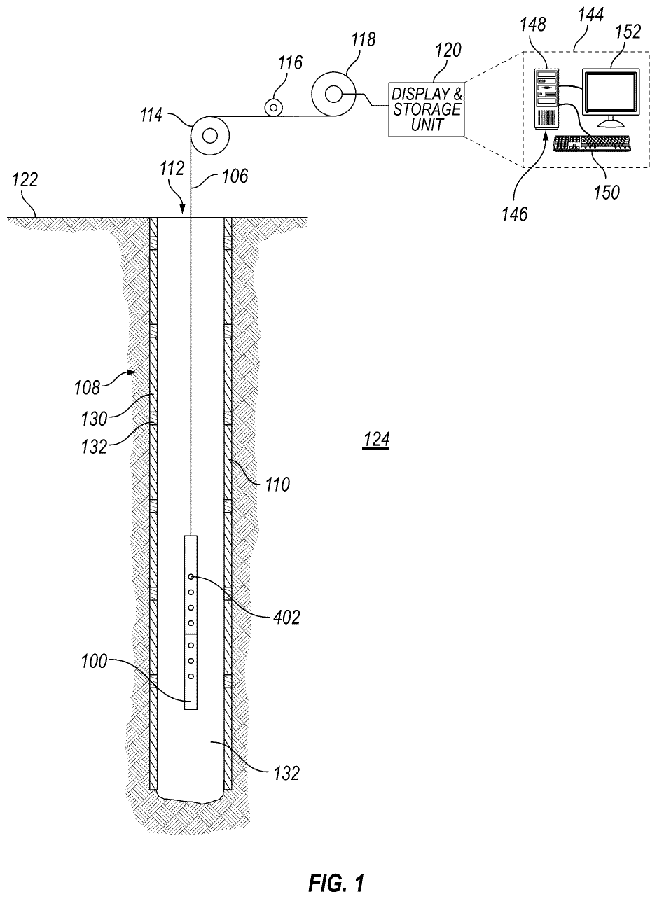

FIG. 1 illustrates an operating environment for an acoustic logging tool 100 in a wellbore 110 as disclosed herein. Acoustic logging tool 100 may comprise a pulse-echo (P-E) transceiver 402. Additionally, P-E transceiver 402 may be configured to rotate in acoustic logging tool 100. In examples, there may be any number of P-E transceivers 402, which may be disposed on acoustic logging tool 100. Additionally, P-E transceiver 402 may be configured to rotate in acoustic logging tool 100. In examples, a rotary motor may be utilized so that annulus impedances at different azimuthal positions may be measured while acoustic logging tool 100 is or is not rotating. Acoustic logging tool 100 may be operatively coupled to a conveyance 106 (e.g., wireline, slickline, coiled tubing, pipe, downhole tractor, and/or the like) which may provide mechanical suspension, as well as electrical connectivity, for acoustic logging tool 100. Conveyance 106 and acoustic logging tool 100 may extend within conduit string 108 to a desired depth within the wellbore 110. Conveyance 106, which may comprise one or more electrical conductors, may exit wellhead 112, may pass around pulley 114, may engage odometer 116, and may be reeled onto winch 118, which may be employed to raise and lower the tool assembly in the wellbore 110. Signals recorded by acoustic logging tool 100 may be stored on memory and then processed by display and storage unit 120 after recovery of acoustic logging tool 100 from wellbore 110. Alternatively, signals recorded by acoustic logging tool 100 may be conducted to display and storage unit 120 by way of conveyance 106. Display and storage unit 120 may process the signals, and the information contained therein may be displayed for an operator to observe and store for future processing and reference. Alternatively, signals may be processed downhole prior to receipt by display and storage unit 120 or both downhole and at surface 122, for example, by display and storage unit 120. Display and storage unit 120 may also contain an apparatus for supplying control signals and power to acoustic logging tool 100. Typical conduit string 108 may extend from wellhead 112 at or above ground level to a selected depth within a wellbore 110. Conduit string 108 may comprise a plurality of joints 130 or segments of conduit string 108, each joint 130 being connected to the adjacent segments by a collar 132.

In logging systems, such as, for example, logging systems utilizing the acoustic logging tool 100, a digital telemetry system may be employed, wherein an electrical circuit may be used to both supply power to acoustic logging tool 100 and to transfer data between display and storage unit 120 and acoustic logging tool 100. A DC voltage may be provided to acoustic logging tool 100 by a power supply located above ground level, and data may be coupled to the DC power conductor by a baseband current pulse system. Alternatively, acoustic logging tool 100 may be powered by batteries located within the downhole tool assembly, and/or the data provided by acoustic logging tool 100 may be stored within the downhole tool assembly, rather than transmitted to surface 122 during logging (corrosion detection).

Acoustic logging tool 100 may be used for pulse excitation of P-E transceiver 402. As illustrated, one or more P-E transceivers 402 may be positioned on the acoustic logging tool 100 at selected distances (e.g., axial spacing) from each other. Specific examples of suitable P-E transceivers 402 may comprise, but are not limited to, piezoelectric elements, bender bars, or other transducers suitable for generating acoustic waves downhole.

Transmission of acoustic waves by P-E transceiver 402 into formation 124 and the recordation of signals by P-E transceiver 402 may be controlled by display and storage unit 120, which may comprise an information handling system 144. As illustrated, the information handling system 144 may be a component of the display and storage unit 120. Alternatively, the information handling system 144 may be a component of acoustic logging tool 100. An information handling system 144 may comprise any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may comprise a processing unit 146 (e.g., microprocessor, central processing unit, etc.) that may process log data by executing software or instructions obtained from a local non-transitory computer readable media 148 (e.g., optical disks, magnetic disks). Non-transitory computer readable media 148 may store software or instructions of the methods described herein. Non-transitory computer readable media 148 may comprise any instrumentality or aggregation of instrumentalities that may retain data and/or instructions for a period of time. Non-transitory computer readable media 148 may comprise, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also comprise input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146. For example, information handling system 144 may enable an operator to select analysis options, view collected log data, view analysis results, and/or perform other tasks.

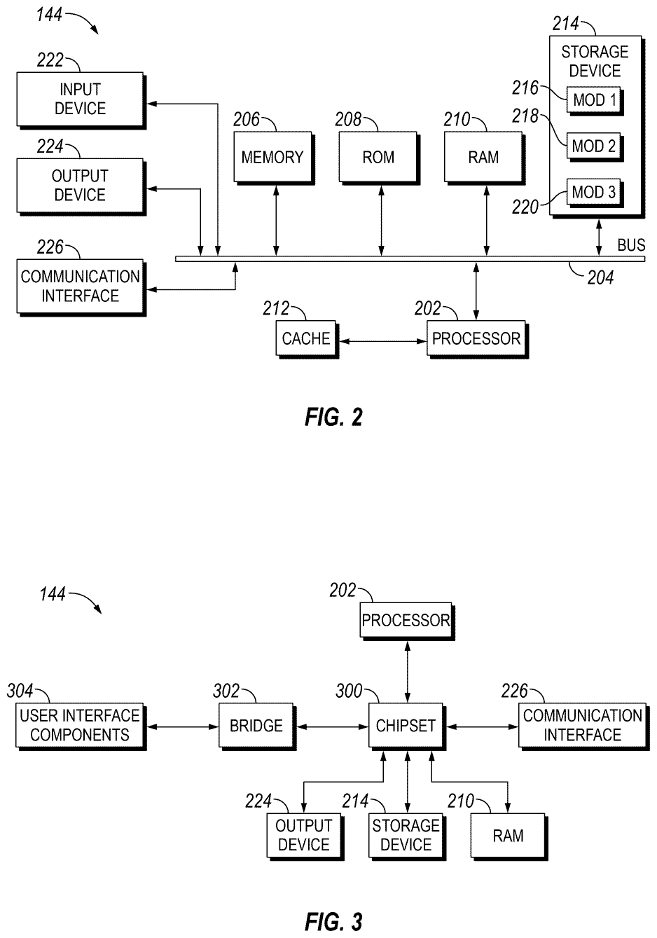

FIG. 2 illustrates an example information handling system 144 which may be employed to perform various steps, methods, and techniques disclosed herein. As illustrated, information handling system 144 comprises a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 144 may comprise a cache 212 of high-speed memory connected directly with, in close proximity to, or integrated as part of processor 202. Information handling system 144 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. Other system memory 206 may be available for use as well. Memory 206 may comprise multiple different types of memory with different performance characteristics. It may be appreciated that the disclosure may operate on information handling system 144 with more than one processor 202 or on a group or cluster of computing devices networked together to provide greater processing capability. Processor 202 may comprise any general purpose processor and a hardware module or software module, such as first module 216, second module 218, and third module 220 stored in storage device 214, configured to control processor 202 as well as a special-purpose processor where software instructions are incorporated into processor 202. Processor 202 may be a self-contained computing system, containing multiple cores or processors, a bus, memory controller, cache, etc. A multi-core processor may be symmetric or asymmetric. Processor 202 may comprise multiple processors, such as a system having multiple, physically separate processors in different sockets, or a system having multiple processor cores on a single physical chip. Similarly, processor 202 may comprise multiple distributed processors located in multiple separate computing devices but working together such as via a communications network. Multiple processors or processor cores may share resources such as memory 206 or cache 212 or may operate using independent resources. Processor 202 may comprise one or more state machines, an application specific integrated circuit (ASIC), or a programmable gate array (PGA) including a field PGA (FPGA).

The information handling system 144 may comprise a processor 202 that executes one or more instructions for processing the one or more measurements. The information handling system 144 may comprise processor 202 that executes one or more instructions for processing the one or more measurements. Information handling system 144 may process one or more measurements according to any one or more algorithms, functions, or calculations discussed below. In one or more embodiments, the information handling system 144 may output a return signal.

Processor 202 may comprise, for example a microprocessor, microcontroller, digital signal processor (DSP), application specific integrated circuit (ASIC), or any other digital or analog circuitry configured to interpret, execute program instructions, process data, or any combination thereof. Processor 202 may be configured to interpret and execute program instructions or other data retrieved and stored in any memory such as memory 206 or cache 212. Program instructions or other data may constitute portions of a software or application for carrying out one or more methods described herein. memory 206 or cache 212 may comprise read-only memory (ROM), random access memory (RAM), solid state memory, or disk-based memory. Each memory module may comprise any system, device or apparatus configured to retain program instructions, program data, or both for a period of time (e.g., computer-readable non-transitory media). For example, instructions from a software or application may be retrieved and stored in memory 206 for execution by processor 202.

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 144, such as during start-up. Information handling system 144 further comprises storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may comprise software modules 216, 218, and 220 for controlling processor 202. Information handling system 144 may comprise other hardware or software modules. Storage device 214 is connected to the system bus 204 by a drive interface. The drives and the associated computer-readable storage devices provide nonvolatile storage of computer-readable instructions, data structures, program modules and other data for information handling system 144. In one aspect, a hardware module that performs a particular function comprises the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 144 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 222 represents any number of input mechanisms, such as a microphone for speech, a touch-sensitive screen for gesture or graphical input, keyboard, mouse, motion input, speech and so forth. Additionally, input device 222 may take in data from one or more sensors 136, discussed above. An output device 224 may also be one or more of a number of output mechanisms known to those of skill in the art. In some instances, multimodal systems enable a user to provide multiple types of input to communicate with information handling system 144. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general-purpose processor. For example, the functions of one or more processors presented in FIG. 2 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) 208 for storing software performing the operations described below, and random-access memory (RAM) 210 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 144 may practice all or part of the recited methods, may be a part of the recited systems, and/or may operate according to instructions in the recited tangible computer-readable storage devices. Such logical operations may be implemented as modules configured to control processor 202 to perform particular functions according to the programming of software modules 216, 218, and 220.

In examples, one or more parts of the example information handling system 144, up to and including the entire information handling system 144, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization computer layer may operate on top of a physical computer layer. The virtualization computer layer may comprise one or more virtual machines, an overlay network, a hypervisor, virtual switching, and any other virtualization application.

FIG. 3 illustrates another example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may comprise a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may comprise, for example, magnetic media, and solid-state media. Chipset 300 may also read data from and write data to RAM 210. Bridge 302 for interfacing with a variety of user interface components 304 may be provided for interfacing with chipset 300. Such user interface components 304 may comprise a keyboard, a microphone, touch detection and processing circuitry, a pointing device, such as a mouse, and so on. In general, inputs to information handling system 144 may come from any of a variety of sources, machine generated and/or human generated.

Chipset 300 may also interface with one or more communication interfaces 226 that may have different physical interfaces. Such communication interfaces may comprise interfaces for wired and wireless local area networks, for broadband wireless networks, as well as personal area networks. Some applications of the methods for generating, displaying, and using the GUI disclosed herein may comprise receiving ordered datasets over the physical interface or be generated by the machine itself by processor 202 analyzing data stored in storage device 214 or RAM 210. Further, information handling system 144 receives inputs from a user via user interface components 304 and executes appropriate functions, such as browsing functions by interpreting these inputs using processor 202.

In examples, information handling system 144 may also comprise tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may comprise RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be comprised within the scope of the computer-readable storage devices.

Computer-executable instructions comprise, for example, instructions and data which cause a general-purpose computer, special purpose computer, or special purpose processing device to perform a certain function or group of functions. Computer-executable instructions also comprise programming modules that are executed by computers in stand-alone or network environments. Generally, program modules comprise routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

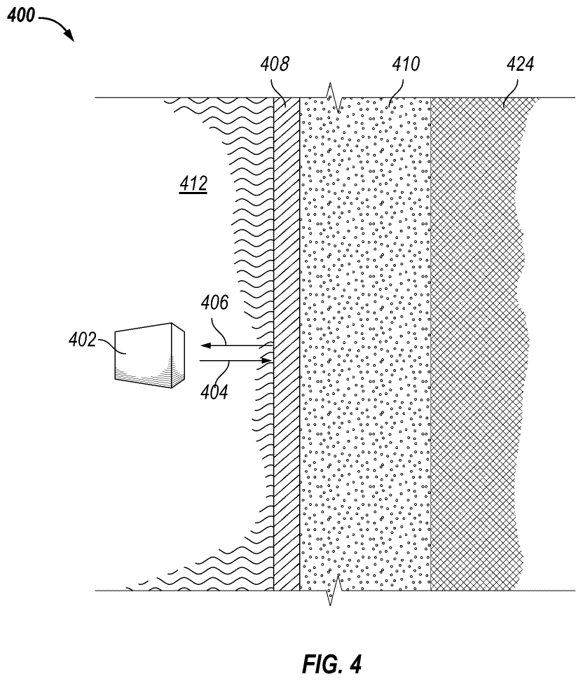

FIG. 4 is a schematic of a system 400 in which a pulse-echo (P-E) transceiver configurations may be utilized and/or disposed on acoustic logging tool 100 (e.g., referring to FIG. 1) during measurement operations. During measurement operations, P-E transceiver 402 may operate in a pulse mode. In pulse mode, P-E transceiver 402 may transmit (e.g., fire) an acoustic wave 404 toward the surface of casing 408. Acoustic wave 404 may be hypersonic or sonic, at normal incidence toward casing 408. After a predetermined time delay to account for the travel time of acoustic wave 404 between P-E transceiver 402 and casing 408, P-E transceiver 402 may switch into a listening mode to detect the reflection of the acoustic waves, echo 406, from casing 408 for cement evaluation. It should be noted that acoustic wave 404 and echo 406 travel through fluid 412 disposed within casing 408. Depending on operational needs, fluid 412 may be water (fresh or brine), water-based drilling fluid or oil-based drilling fluid. During the listening mode, echo 406 may be recorded and/or measured as data. The data may be transmitted to information handling system 144, using the methods and systems described above, to determine acoustic impedance of substance behind casing 408. To survey three hundred and sixty degrees within casing 408, P-E transceiver 402 may be disposed on a rotary motor within acoustic logging tool 100, which may allow P-E transceiver 402 to rotate relative acoustic logging tool 100 in three hundred and sixty degrees. This may allow acoustic logging tool 100 to measure an annulus impedance at different azimuthal angles. As the tool traverse the depth of the well, a complete measure of the acoustic impedance of the section of well of interest is obtained.

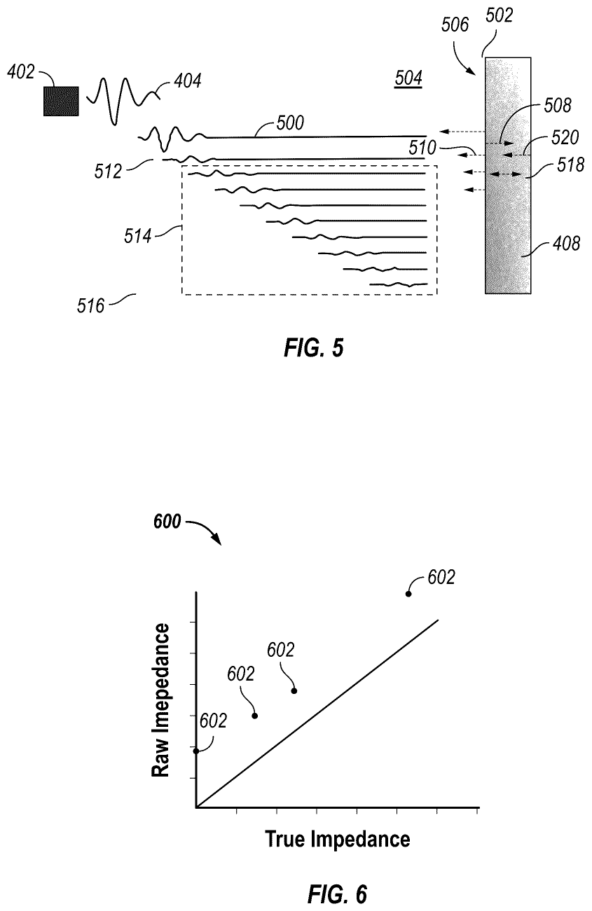

FIG. 5 illustrates a pulse-echo measurement operation. Specifically, FIG. 5 illustrates the physics phenomenon that an acoustic wave 404 and echo 406 may experience during the pulse-echo measurement operations. For example, P-E transceiver 402 may emit (e.g., fire) an acoustic wave 404 at a frequency typically around hundreds of kilohertz which is recommended to be close to the resonance frequency of casing 408. The resonance frequency may be dependent on the thickness of casing 408 and compressional speed of sound (assuming a normal incidence of acoustic wave 404). The resonance frequency may be estimated as:

$${f}_{res} = \frac{{V}_{s}}{2 {C}_{t}} \qquad ( 1 )$$

where Vₛ is the compressional speed of sound, Cₜ is the thickness of casing and fᵣₑₛ is the resonance frequency of casing 408. First reflection 500 (which may also be referred to as echo 406) happens once acoustic wave 404 reaches fluid-casing interface 502 between fluid 504 and casing inner surface 506. The amplitude ratio between first reflection 500 and amplitude of acoustic wave 404, may be governed by a reflection coefficient between the fluid-casing interface r_{fc} in the case of plane wave propagation:

$${r}_{fc} = \frac{{Z}_{c} - {Z}_{f}}{{Z}_{c} + {Z}_{f}} \qquad ( 2 )$$

where Z_{c} is casing acoustic impedance and Z_{f} is fluid acoustic impedance. At least portion of the energy from acoustic wave 404 may enter casing 408, identified as refracted acoustic wave 508. The amplitude of refracted acoustic wave 508 may be determined by the transmission coefficient between the fluid-casing interface t_{fc}:

$${t}_{fc} = \frac{2 {Z}_{c}}{{Z}_{c} + {Z}_{f}} \qquad ( 3 )$$

Acoustic wave 404 may be reflected between casing-cement interface 518 and transmitted back to P-E transceiver 402 as first reverberation 512 which has much smaller amplitude than first reflection 500 as according to similar relationships described in above equations. Acoustic wave 404 may further reverberate between the two surfaces of casing 408. As a result, the recorded waveform may be a superimposition of first reflection 500, first reverberation 512 and all subsequent reverberations 514. In examples, this may be a superimposition of first reflection from inner surface of casing and/or subsequent reverberations from the casing or just a measurement.

According to physics phenomenon described in FIG. 5, pulse-echo (PE) measurement for cement evaluation may be simplified as a 1-dimensional fluid-casing-annulus three-layer model. Knowing the acoustic impedances of fluid 504, casing 408 and annulus, thickness of the casing and compressional speed of sound of casing, received acoustic waveform 516 may be computed from P-E transceiver 402. It should be pointed out that the need for real time operation coupled with the large amount of real data throughput necessitates the utilization of this three-layer model for real time cement impedance measurement. Yet it is known that such simple approach falls short for several reasons. First, there is the 3-dimensional nature of the environment. A finite size of P-E transceiver 402 produces acoustic waves 404 that deviates from 1D plane wave due to beam spreading and propagation losses. This has a large impact on first reflection 500. Second, the non-planer curvature of casing 408 complicates the travelling directions of first reflection 500 and reverberations 514. Third, In the presence of attenuative fluid, such as heavy oil-based drilling mud, the amplitude of received acoustic waveform 516 decays much more rapidly than non-attenuative fluid.

FIG. 6 illustrates an example of a graph 600 directly using a 1D three-layer model to predict annulus impedance, where x axis is the true impedance values, y axis is the inverted impedance value, points 602 show the values of true impedance versus inverted impedance from waveforms measured in a system depicted in FIG. 5. Without consideration on the detailed physics phenomena the 1D model impedance is off from true impedance values. For example, 1D models may need environmental corrections. As noted above, a 1D model is used for real time impedance inversion given its speed and simplicity. However, there may exist gaps between the forward model and actual physics environment. For example, the 1D model does not consider the amplitude change due to wave propagation and diffraction, or reflection/transmission of waveform over curved casing surfaces, or signal attenuation while the wave travels through frequency selective attenuative fluid such as oil-based mud. Consequently, additional corrections are carried out on attribute(s) values to remove certain dependencies on these environmental parameters. These corrections comprise, but are not limited to standoff correction, mud attenuation correction, curvature correction, eccentricity correction, and/or rugosity correction. FIGS. 5 and 6 demonstrate annulus impedance error due to an oversimplified model, a more accurate method may be utilized to predict annuls impedance.

Conventionally the 1D three-layer model may be used to invert for impedance. Since it does not capture the full 3D physics, calibration is often needed to correct the inverted impedance to match true impedance. Such calibration may be carried out in a laboratory with setup that closely matches field operations. This operation is often time-consuming and costly. It is highly desirable to reduce or eliminate the need for such calibration procedures. Further the laboratory setting never fully simulates the nature of the tool environment downhole.

In one example, the calibration may be carried out real time, near real time, or post-process, i.e., after the logging operation as opposed to prior to the logging operation. The calibration scheme may utilize down hole data to provide a profile on acoustic wave 404, the unique signature for each P-E transceiver 402 which may vary over time, with temperature, pressure, and fluid environment. The scheme makes use of acoustic waves 404 on casing positions which do not resonate in the frequency range of the source pulse energy. These positions may be identified from the collected data and generally are in casing collar positions (the joint between two casings) which is a thicker position of metal along the casing and therefore outside the resonant frequency range of the source pulse. The best data may be selected for first reflection extraction by, identifying the collar positions, identifying the locations therein of low eccentricity, identifying the locations therein of low rugosity, identifying the locations therein of strongest signal-to-noise-ratio (SNR), and/or, identifying positions therein of greatest normality in a distribution sense. Transducer source pulse can then be derived from downhole extracted first reflection by dividing reflection coefficient between borehole fluid and casing interface.

Although the screening herein was presented as recursive any combination and any order of these attributes may be adopted for screening the best source pulses. Further, with many potentially good locations in a well for source pulse extraction, a composite source pulse extraction may be performed with more than one location. This composite may be a simple average or may be a map or function derived with depth, temperature, pressure mud weight, or another wellbore attribute. Once the source pulse is extracted, it may be used with the inversion in order to derive more accurate wave attributes based on the inversion analysis described herein.

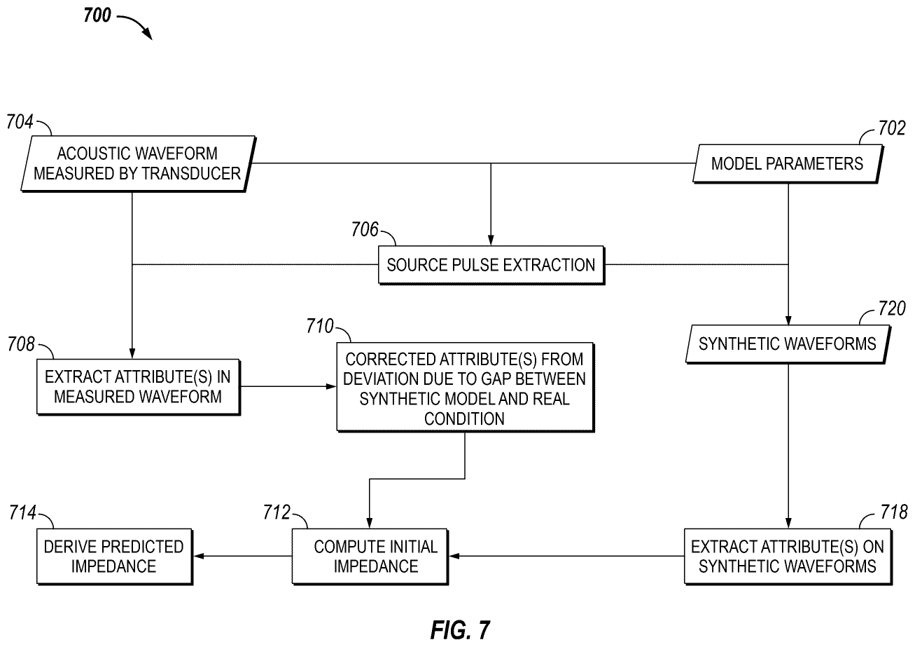

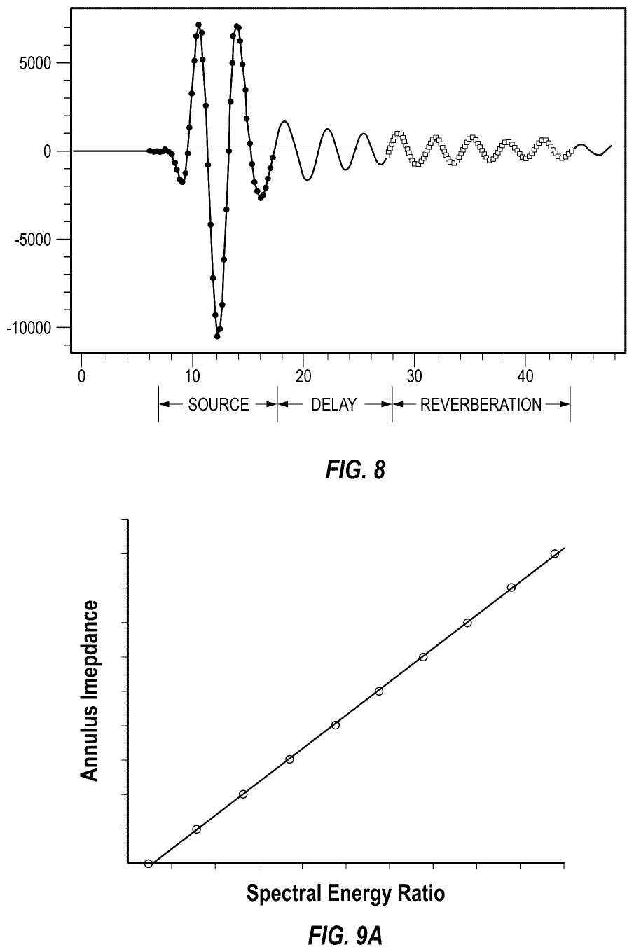

FIG. 7 is a workflow 700 that may be utilized to predict an annulus impedance. It should be noted that workflow 700 may be performed at least in part on information handling system 144. Workflow 700 may begin, at least in part, with block 702 with modeled parameters. The model parameters may comprise of parameters that determine measured waveform from P-E transceiver 402 (e.g., referring to FIG. 4) after propagation through the pulse-echo system. Parameters may comprise properties of the fluid inside casing such as density, speed of sound through fluid medium and acoustic attenuation coefficient of the fluid; the properties of the casing material, such as density, compressional and shear wave velocities; the properties of the annulus material including density, compressional and shear wave velocities through the annulus medium; and geometrical parameters such as casing thickness and casing inner/outer diameters.

To inverse for determining annulus impedance, a forward model may be utilized. To derive measured waveform in block 704 from model parameters in block 702 a synthetically acoustic wave may be formed with a forward model. This forward model may be the 1D three-layer model mentioned above, or more complex higher dimensional forward modelling method with better accuracy, such as finite difference time domain simulation. In one example, the downhole extracted first reflection, discussed below, together with a forward model based on full 3-dimensional physics to invert for true impedance. The 3 dimensional model may be a wave equation solver based on Finite Difference Method (FDM), Finite Element Method (FEM), or advanced machine learning models such as Fourier Neural Operator (FNO), Physics-Informed Neural Networks (PINN), Deep-Generative Neural Operator (DGNO), or other physics, or proxy method such as empirical or semi-empirical modeling. As described below, with synthetic model and emitted acoustic wave 404 may be extracted from measured waveform in block 704 and model parameters in block 702. In examples, acoustic wave 404 may be the same as the source pulse.

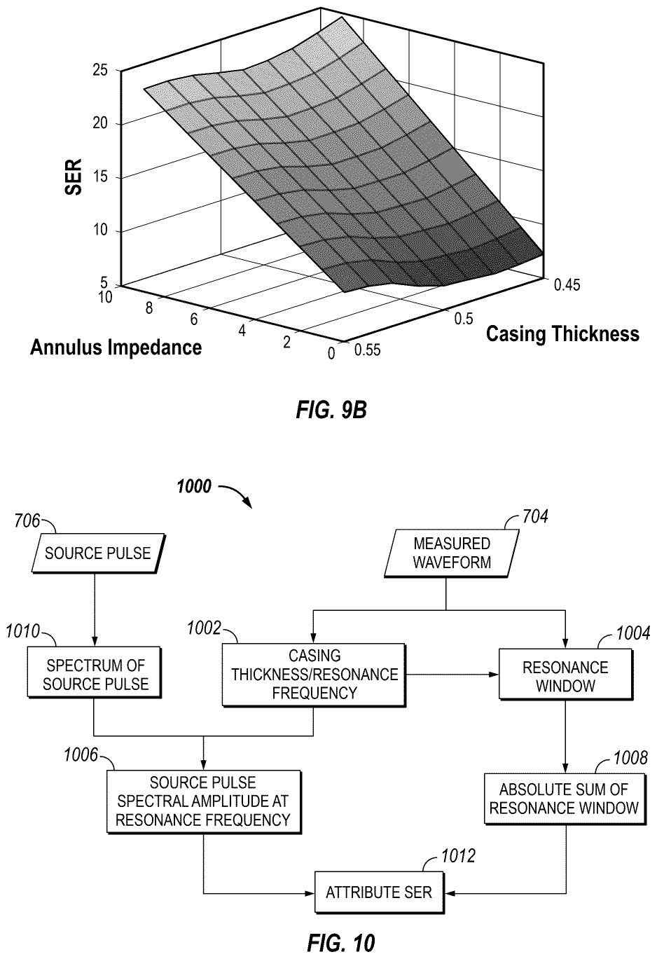

In block 706, an extracted source pulse, a series of synthetic waveforms may be generated using a forward model according to different model parameters, such as different casing thicknesses and annulus impedances. In examples, the source pulse is the pseudo pressure pulse emitted from the transducer, which cannot be measured directly. In examples, there may be two or more methods to derive source pulse. First, a method is downhole first reflection to directly measure 1^{st} reflection where the pipe is very thick; second, a method to mathematically extract 1^{st} reflection using forward model. Either way, obtained 1^{st} reflection will be scaled to represent source pulse. The source pulse is directly extracted from the measured pulse-echo waveform in block 704. Simple segmentation of the pulse-echo signal may result in source pulse that is contaminated by casing reverberations, as illustrated in FIG. 9A. To reduce this contamination, methods may be used to subtract some reverberations, as discussed in FIG. 5. The source pulse may be used in connection with forward modeling in block 720, a contaminated source pulse may lead to errors in the final impedance. Hence, it is desirable to have a source pulse that is free from such contaminations by extracting downhole first reflection.

Methods may be utilized to extract first reflection from downhole pulse-echo logging data by identifying captured waveforms with the least amount of energy in the time window associated with casing reverberations. The energy is calculated as a summation of the reverberations portion of the signal. For example, information entropies of the waveform are calculated for each scan as acoustic logging tool 100 traverses wellbore 110 (e.g., referring to FIG. 1). First reflection is identified as the waveform with the maximum entropy. In another example, location of the casing collars may be identified by collapsing the 2-dimensional acoustic impedance of wellbore 110 in the azimuthal direction, resulting in a one-dimensional curve of acoustic impedance vs. depth of the well. Maxima in this curve identify location (i.e., depth z values) of casing collars. Then first reflection may be extracted at each casing collar location by selecting the waveforms captured with zero tool eccentricity. In yet another example, First reflection for a given P-E transceiver 402 may be directly measured in a laboratory for given casing 408 and acoustic logging tool 100 configurations. This data is then stored into memory for later use. Source pulse can be derived from downhole first reflection by dividing reflection coefficient between borehole fluid and casing interface. Once a source pulse is extracted attributes from synthetic waveforms may be found.

In block 708, extracting attribute(s) in measured waveforms may be performed. This also may allow for calculation of synthetic waveforms initial attributes in block 720. The initial attribute(s) extracted in block 720 and/or the attributes calculated in block 708 may incorporate resonance part of the waveform which “sees” the annulus. The attribute(s) may be the sum of absolute amplitude of a section in resonance (resonance sum, or Rsum), spectral energy ratio (SER), and/or group delay of the frequency spectrum of the whole waveform at resonance frequency.

For extracting parameters in blocks 708 and/or 720, a relationship between all attributes and annulus impedance Z_{c} may be established. In examples, new attributes may be spectral energy ratio (SER) as the ratio between the amplitude at resonance frequency in spectrum of the source pulse and the amplitude at resonance frequency in spectrum of a section in resonance. In other examples, the Rsum of the same section in resonance may be used as denominator in SER definition. Since, for synthetic waveforms, both annulus impedances and attribute(s) values are known, a correlation between synthetic attribute(s) and model parameters may be established. One way is to create synthetic waveforms with all the other model parameters. To establish the correlation between synthetic attribute(s), one or more synthetic waveforms may be created with all the other model parameters in block 702 fixed and by varying impedance in a certain range, such as between 0 and 9 Mryals with 1 Mryal interval. A linear correlation may be established as shown in FIG. 9A. In FIG. 9A, the x-axis is spectral energy ratio (SER), discussed below, and the y-axis is annulus impedance Z_{c}. In another example, two variables (both annulus impedance and casing thickness) may be varied at the same time for synthetic waveform generation. This may allow for a multi-dimensional relationship among the variables. Additionally, a lookup table or surface correlation may be established to show the multi-dimensional relationship among casing thickness, attribute(s) from synthetic waveforms, and annulus impedance as shown in FIG. 9B for when using the SER as a signal attribute. FIG. 9B is a graph 900 that may be utilized to establish a correlation among casing thickness, annulus impedance, and SER, as shown in the graph.

Still referring to blocks 708 and/or block 720, in other examples, with measured waveform and extracted source pulse form block 706, attribute(s) from measured acoustic waveform may be extracted. Since there might be a gap between forward model and actual physics phenomenon, i.e., 1D model does not consider the amplitude change due to propagation, reflection/transmission of waveform over curved casing surfaces and attenuation while travelling through attenuative fluid such as oil-based mud, corrections are done on attribute(s) values to remove dependencies over these matters. From linear correlation demonstrated in FIG. 9A, or lookup table/surface correlation shown in FIG. 9B, initial annulus impedance according to corrected attributes from measured waveform may be derived. This allows for the method to form corrected attributes. The initial annulus impedance, though its value has minimal dependency on various parameters such as fluid attenuation coefficient and standoff, it may not be matching exactly with true annulus impedance. A secondary correction is done to map initial impedance to its true value, where predicted impedance is derived as final output.

When SER is selected as inversion attribute in block 708 and/or block 720, FIG. 10 illustrates a workflow 1000 for the process of calculating a SER attribute. SER may be utilized as a measurement of acoustic impedance in the annulus. Signal attributes used to determine annulus impedance comprise the resonance sum (Rsum), which is defined as the summation of the absolute values of a portion of the reverberation signal, and group delay of the frequency spectrum of the whole waveform at casing resonance frequency. As disclosed below, SER is defined as the ratio between the value of the amplitude spectrum of the source pulse at the resonance frequency and to the energy of the reverberation signal represented by Rsum. It should be noted that workflow 1000 may be performed at least in part on information handling system 144. Workflow 1000 may begin with block 706 to extract a source pulse and block 704 for a measured waveform. Workflow 1000 may continue with block 1002 in which a resonance frequency and a casing thickness are firstly derived from the measured waveform. The casing resonance frequency may be derived in a few ways. One way is to take fast Fourier transform (FFT) of the whole measured waveform and check the position of a notch in the amplitude spectrum. The frequency at the notch position is the resonance frequency of casing in block 1002. It may also be derived by checking frequency at spectral peak of a certain length of samples in the resonance section. Casing thickness in block 1002 may be calculated from resonance frequency as:

$${C}_{t} = \frac{{V}_{s}}{2 {f}_{res}} \qquad ( 4 )$$

where Vₛ is the compressional velocity of casing, and fᵣₑₛ is the resonance frequency. A section of resonance part (block 1004 in which a resonance window is identified), such as 3-5 cycles in length at resonance frequency at a certain distance from 1^{st} echo (i.e. 3-5 resonance cycles away from maximum peak of the 1^{st} echo) is extracted from measured waveform in block. This may be utilized to calculate resonance sum (Rsum) in block 1008 as:

$${R}_{sum} = \sum \vert x \vert \qquad ( 5 )$$

where x is an amplitude of sampling points within resonance window of block 1004. In examples, a resonance window is defined in equation (4), as a section of resonance part (block 1004 in which a resonance window is identified), such as 3-5 cycles in length at resonance frequency at a certain distance from 1^{st} echo (i.e. 3-5 resonance cycles away from maximum peak of the 1^{st} echo) is extracted from measured waveform in block. In block 1010 spectrum of the source pulse may be the spectrum amplitude by taking magnitude of each frequency component of the source pulse. There are a few merits of using SER as an inversion attribute. Since SER is taking as the ratio of amplitudes between the first echo and resonance window at the same frequency, it is not impacted by spurious signal that may be present at frequencies. Furthermore, both the first echo and resonance travel through the same path within the casing. By taking the ratio at the same frequency, amplitude change due to travelling within attenuative fluid is largely cancelled out. Thus, the SER attribute is significantly independent of mud attenuation.

As the speed of sound for casing material is faster than the speed of sound for fluid 504 inside casing 408 (e.g., referring got FIG. 5), first or first few reverberations 514 may arrive at P-E transceiver 402 together with the tail of first reflection 500 (e.g., referring to FIG. 5). First reflection 500 needs to be separated from reverberations 514 in order to have an accurate measurement of source pulse from block 706 (e.g., referring to FIGS. 7, 10, and 11) for annulus impedance derivation. In examples, this is another method to obtain 1^{st} reflection. The product of both methods are source pulse 706. In examples, only one method is required but both may be used for source pulse extraction.

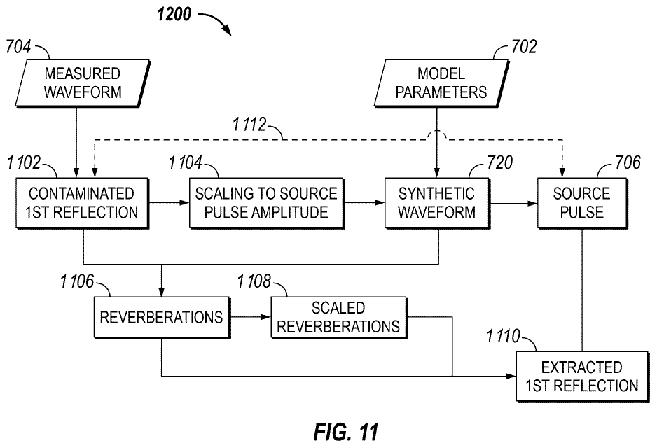

In block 718, FIG. 11 illustrates a workflow 1100 for extracting a source pulse from a measured waveform using a 1D model may be performed. It should be noted that workflow 1100 may be performed at least in part on information handling system 144. A section of the waveform which contains the whole duration of first reflection 500 in block 1102 is extracted from measured waveform taken in block 704. This first reflection 500 may comprise early arrivals of reverberations 514 which may need to be removed. To do that, contaminated first reflection in block 1102 may be scaled up to the amplitude of source pulse in block 706 by dividing the reflection coefficient at fluid-casing interface which is defined as:

$${R}_{1} = \frac{{Z}_{s} - {Z}_{m}}{{Z}_{s} + {Z}_{m}} \qquad ( 6 )$$

where R₁ is the reflection coefficient between fluid and casing interface, Zₛ is the acoustic impedance of casing and Zₘ is the acoustic impedance of fluid.

In block 718, the scaled contaminated source pulse in block 1104, together with the model parameters from block 702 may be used to create synthetic waveform according to annulus impedance. In examples, the annulus impedance may either be nominal value of cement used in annulus, an initial guess, output from previous impedance calculation at previous azimuthal position or solved iteratively. The difference between synthetic waveforms in block 718 and contaminated first reflection in block 1102 forms the reverberation part of a waveform in block 1106. Due to the difference between synthetic model and actual situation, the amplitude of reverberation may not match well with measured waveform in block 701. The synthetic reverberations may be scaled in block 1108 to match with actual amplitude by:

$${A}_{r \_ scaled} = {A}_{r} \cdot {S}_{1} \qquad ( 7 )$$

where Aᵣ is the amplitude of initial reverberations in block 1106, A_{r_scaled} is the reverberations amplitude after scaling in block 1108. S₁ is the scaling factor which may either be established from experimental observation or numerical simulations. The difference between contaminated 1^{st} reflection 1102 and scaled reverberations 1108 forms the clean version of 1^{st} reflection in block 1110. By dividing 1^{st} reflection in block 1110 with reflection coefficient R₁, source pulse from block 706 may be recovered. This process achieves 1^{st} order accuracy on recovering the source pulse from block 706. Additionally, as showing by arrow 1112, a more accurate source pulse from block 706 may be computed by taking extracted source pulse from block 706 as a new contaminated 1^{st} reflection in block 1102 and reiterate the same process for a second time or multiple times to find a 1^{st} reflection in block 1110.

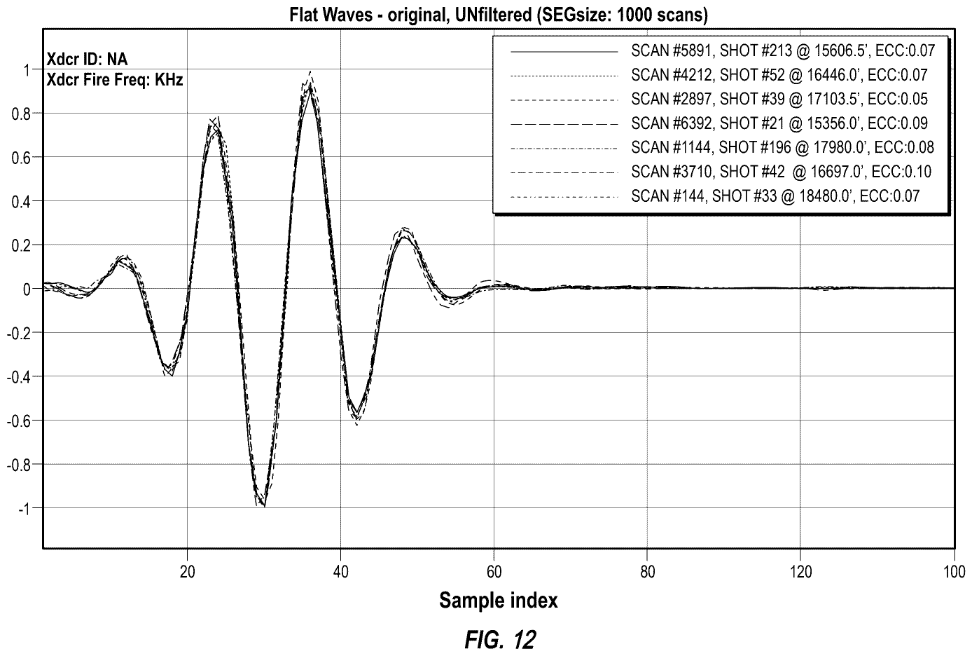

In other examples, a more accurate representation of a source pulse from P-E transceiver 402 may be obtained in situ (i.e. during the logging operation) or later from the recorded data by searching for waveforms displaying a flat or nearly flat signal in the time window for casing reverberations. Such flat waves are most likely to be detected in front of casing collars that join two casing sections together. The flatness of the casing signal shows there is no interference of pipe signals on the first reflection. Therefore, this signal has the same spectral distribution of the source pulse. FIG. 12 is a graph that illustrates some recovered echoes, acquired at different depths from the recoded data, which show no significant oscillations originating from energy bouncing within the casing 408 (e.g., referring to FIG. 5).

The source pulse from P-E transceiver 402 obtained using the method detailed above must be corrected to be representative of the pulse incident on casing inner surface 506. The techniques described herein for signal corrections may also apply here. Though the synthetic model takes care most of the model settings such as material properties of fluid, casing and annulus, and thickness of casing, the initial attribute(s) selected for inversion in block 708 (e.g., referring to FIG. 7) may still show dependency on some parameters, particularly the standoff, fluid acoustic attenuative coefficient and surface curvature of casing.

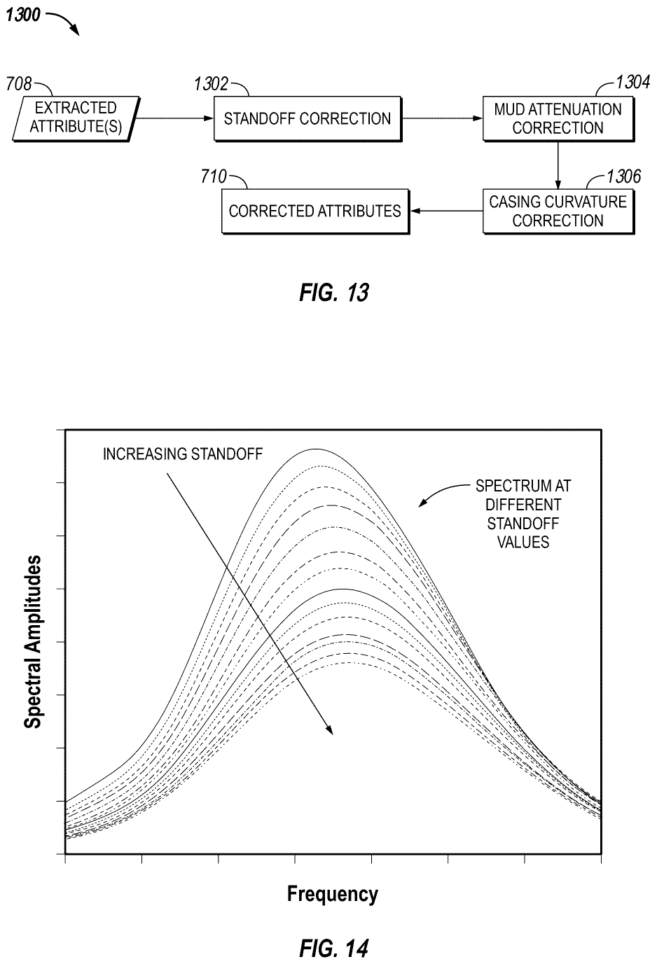

FIG. 13 illustrates workflow 1300 for deriving corrected attribute, as performed in block 710, from initial attribute in block 708. It should be noted that workflow 1300 may be performed at least in part by information handling system 144. Workflow 1302 may operate by correcting for waveform propagation against different standoff distance in block 1302, through fluid with different acoustic attenuative coefficient in block 1304 and casings 408 (e.g., referring to FIG. 5) with different sizes/surface curvatures in block 1306.

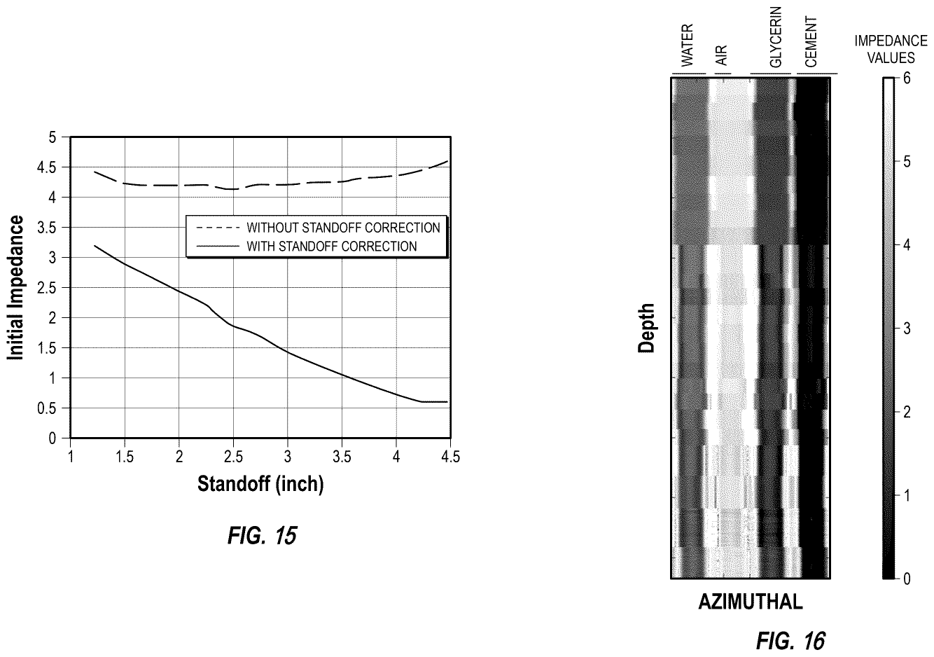

The 1^{st} echo amplitude measured by P-E transceiver 402 (e.g., referring to FIG. 5) depends on multiple factors, including the beam patterns which in turn is impacted by characteristics of P-E transceiver 402, such as its operational frequency and its area of pulse excitation, the distance the waveform travelled (standoff) and fluid properties such as speed of sound and attenuation coefficient. To illustrate this point, FIG. 14 shows a graph 1400 of the power spectral density of first reflection 500 (e.g., referring to FIG. 5) measured for P-E transceiver 402 placed at different distances (standoff) in front of a flat steel at normal incidence. In general, the amplitude in first reflection 500 decreases linearly in log scale with increasing standoff value in linear scale (when standoff is larger than the near field distance). Knowing the amplitude ratio between two different standoff values, a gain factor may be applied to convert 1^{st} reflection amplitude from one standoff to another, such as:

$${A}_{res \_ stdoff 2} = {A}_{res \_ stdoff 1} \cdot {g}_{1} \qquad ( 8 )$$

where A_{res_stdoff2} is the spectral amplitude of source pulse at resonance frequency with standoff position to be converted to, and A_{res_stdoff1} is the spectral amplitude of source pulse at resonance frequency and measured standoff distance. The gain factor g₁ may either be established from tests, numerical simulations or derived from analytical formula for wave propagation. Note that gain factor g₁ is frequency dependent, the same process may be repeated for all the frequencies which forms a full spectrum correction for standoff. The choice of single frequency or full spectrum correction would depend on the inversion attribute chosen. Once spectrum amplitude is corrected to the same reference standoff position, i.e. a 2″ standoff distance, dependency of 1^{st} echo part of attribute on standoff distance would be removed. Similar practice may be done to resonance sum such as:

$${R}_{sum \_ stdoff 2} = {R}_{sum \_ stdoff 1} \cdot {g}_{2} \qquad ( 9 )$$

where g2 is the ratio between absolute sum of selected resonance window (resonance sum) propagated at two different standoff values (R_{sum_stdoff2} and R_{sum_stdoff1}). Unlike 1^{st} echo, the gain factor of resonance window only depends on resonance frequency hence full spectrum correction is not necessary. Gain factor g2 may also be established via tests, numerical simulation or from analytical derivation. In general, the impact of waveform propagation on resonance sum is much smaller than 1^{st} echo therefore g₂ with value of 1 provides satisfactory results in terms of standoff dependency. Combining the newly derived variables, the standoff independent SER attribute may be calculated as:

$${SER}_{corr} = \frac{{A}_{res \_ stdoff 2}}{{R}_{sum \_ stdoff 2}} \qquad ( 10 )$$

where SER_{corr} is SER attribute with standoff dependency corrected. FIG. 15 is a graph 1500 that shows the computed initial impedance from test with different standoff values before and after standoff correction. As illustrated, after standoff correction initial impedance changes much less against different standoff values than without standoff correction.

If the fluid is attenuative, the relationship between attenuated amplitude A (d) and initial amplitude A₀ after travelling for a distance of d follows as

$$g = A ( d ) / {A}_{0} = {e}^{α ( ω ) d} \qquad ( 11 )$$

where α is attenuative coefficient of fluid, ω is angular frequency and g is the gain factor due to travelling through attenuative fluid. By dividing the gain factor g from the amplitude part in selected attribute(s) the impact of fluid attenuation at angular frequency ω is removed. This method may be applied to remove fluid attenuation impact from both amplitude at a particular angular frequency, or full spectrum at all frequencies. Particularly, if SER is selected as inversion attribute, since 1^{st} echo and reverberations travel the same path hence have undergone the same amount of attenuation, they experience the same amount of decay which cancels the fluid attenuation impact intrinsically. Therefore, no fluid attenuation correction is required for SER.

Referring back to FIG. 13, the correction for casing curvature in block 1306 may be performed by dividing initial attribute from measured waveform in block 708 by a reference attribute value from a reference waveform with known annulus impedance using the same type of P-E transceiver 402, with the same model parameter. By doing so, the system response inside the casing-annulus interface is cancelled. Thus, the residual attribute would solely depend on the difference between annulus impedance and the known annulus impedance of the reference waveform. The reference waveform may either be measured in a laboratory condition or numerically simulated. The resultant corrected attribute in block 710, after removing the dependencies on standoff, mud attenuation (if necessary) and casing curvature, is then used to derive initial impedance in block 712 (e.g., referring to FIG. 7). In block 712, initial impedance may be computed. Depending on the selected forward model, a combination of standoff correction in block 1302, mud attenuation correction in block 1304 or casing curvature correction in block 1306 may be applied where applicable. Forward model is used to create synthetic waveforms (from material properties and casing thickness). Attributes may be extracted from synthetic waveforms at varying impedances (sometimes also varying casing thicknesses) and measured waveforms; by comparing attribute from measured waveform with attributes from synthetic waveforms, impedance is derived. The choice of corrections depends on forward model used and type of attribute selected for inversion (SER, group delay, Rsum, only one type of attribute is needed). i.e. when 1D model is used and SER chosen for inversion, all corrections are needed except for mud attenuation correction.

The resulted initial impedance only depends on reference impedance used during casing curvature correction in block 1306 and annulus impedance. A general correlation may be established either via experiments or numerical simulation in the form of:

$${Zc}_{pred} = A \cdot {Zc}_{initial} + B + {Zc}_{ref} \qquad ( 12 )$$

where Zcᵢₙᵢₜᵢₐₗ is the initial impedance in block 712 (e.g., referring to FIG. 7), Zc_{ref} is the reference annulus impedance corresponding to reference waveform used for casing curvature correction in block 1306, Zc_{pred} is the predicted impedance in block 714 (e.g., referring to FIG. 7), A and B are correlation coefficients. A higher order correction such as quadratic fitting may also be applied to more accurately describe the relationship between initial impedance in block 712 (e.g., referring to FIG. 7) and final predicted impedance.

Using workflow 700 proposed in FIG. 7, FIG. 16 illustrates predicted annulus impedance for waveforms acquired from laboratory experiments over twenty-four different testing parameter configurations with multiple fluids inside casing, multiple thicknesses of casing, multiple size of casing and multiple different distances between transducer and casing. In examples only a single testing parameter configuration may be applies or multiple. Outside of the casing the annulus is divided into four quadrants by thin steel sheets where each quadrant is filled with annulus materials with known acoustic impedances, water, glycerin, air, and well bonded cement. The predicted azimuthal annulus impedances are stacked into the same figure with x direction the azimuthal and y direction the different test sets. As demonstrated in the figure, all the four annulus quadrants are clearly identified, and their impedance values are accurately represented.

Improvements discussed above may comprise improved methods and systems to extract source pulse with consideration on amplitude difference between 1D model and 3D real situation. A new attribute for impedance inversion that focuses on single frequency independent of drilling fluid acoustic attenuation. Correction on amplitude change during propagation to remove impact of propagation distance. Correction on the effect of curvature to remedy the impact of casing curvature and a new calibration scheme.

The systems and methods for using a distributed acoustic system in a downhole environment may comprise any of the various features of the systems and methods disclosed herein, including one or more of the following statements. Additionally, the systems and methods for an acoustic tool in a downhole environment may comprise any of the various features of the systems and methods disclosed herein, including one or more of the following statements.
Statement 1. A method comprising: disposing an acoustic logging tool into a wellbore, wherein the acoustic logging tool comprises a P-E transceiver; transmitting one or more acoustic waves from the acoustic logging tool with the P-E transceiver; recording an acoustic waveform that is a superimposition of first reflection from inner surface of casing and/or subsequent reverberations from the casing with the P-E transceiver; creating synthetic waveforms from source pulse and a testing parameter configuration; identifying one or more model parameters of the wellbore; and deriving a predicted impedance from at least the one or more model parameters of the wellbore and the acoustic waveform.
Statement 2. The method of statement 1, further comprising extracting a source pulse according to the model parameters.
Statement 3. The method of statement 2, wherein extracting the source pulse incorporates determining pulse excitation by identifying captured waveforms with the least amount of energy in a time window associated with casing reverberations.
Statement 4. The method of statement 3, wherein the least amount of energy is calculated as a summation of a reverberations portion of the pulse excitation.
Statement 5. The method of statements 2-4, further comprising determining one or more attributes of measured waveforms.
Statement 6. The method of statement 5, wherein the one or more attributes comprise a sum of absolute amplitude of a section in resonance (Rsum), and/or a spectral energy ratio (SER).
Statement 7. The method of statement 6, wherein determining SER is calculated at least with the source pulse, a resonance frequency and a casing thickness are firstly derived from the acoustic waveforms, a resonance window of the acoustic waveforms, and amplitude spectrum of the source pulse.
Statement 8. The method of statements 1-7, further comprising determining one or more attributes of the synthetic waveforms.
Statement 9. The method of statement 8, wherein determining one or more attributes of the synthetic waveform comprises at least calculating reflection coefficient between fluid and casing interface, with:

$${R}_{1} = \frac{{Z}_{s} - {Z}_{m}}{{Z}_{s} + {Z}_{m}}$$

where R₁ is the reflection coefficient between fluid and casing interface, Zₛ is the acoustic impedance of casing and Zₘ is the acoustic impedance of fluid, and scaling reverberation with:

$${A}_{{r}_{scaled}} = {A}_{r} \cdot {S}_{1}$$

where Aᵣ is an amplitude of initial reverberations, A_{r_scaled} is a reverberations amplitude, S₁ is a scaling factor which may either be established from experimental observation or numerical simulations.
Statement 10. The method of statements 8 or 9, further comprising correcting the one or more attributes of the a superimposition of first reflection from inner surface of casing and/or subsequent reverberations from the casing.
Statement 11. The method of statement 10, wherein correcting the one or more attributes of a superimposition of first reflection from inner surface of casing and/or subsequent reverberations from the casing comprises a standoff correction, a mud attenuation correction, and/or a casing curvature correction to form corrected attributes.
Statement 12. The method of statement 11, further comprising computing initial impedance with the corrected attributes from measured waveform and attributes from synthetic waveforms.
Statement 13. A system comprising: an acoustic logging tool disposed in a wellbore, wherein the acoustic logging tool comprises a P-E transceiver configured to: transmitting one or more acoustic waves from the acoustic logging tool with the P-E transceiver; and recording an acoustic waveform that is a superimposition of first reflection from inner surface of casing and/or subsequent reverberations from the casing with the P-E transceiver; an information handling system configured to: create synthetic waveforms from source pulse and a testing parameter configuration; identify one or more model parameters of the wellbore; and derive a predicted impedance from at least the one or more model parameters of the wellbore and the acoustic waveform.
Statement 14. The system of statement 13, wherein the information handling system is further configured to extract a source pulse according to the model parameters.
Statement 15. The system of statement 14, wherein extracting the source pulse incorporates determining pulse excitation by identifying captured waveforms with the least amount of energy in a time window associated with casing reverberations.
Statement 16. The system of statement 15, wherein the least amount of energy is calculated as a summation of a reverberations portion of the pulse excitation.
Statement 17. The system of statements 14-16, wherein the information handling system is further configured to determine one or more attributes of measured waveforms.
Statement 18. The system of statement 17, wherein the one or more attributes comprise a sum of absolute amplitude of a section in resonance (Rsum), and/or a spectral energy ratio (SER).
Statement 19. The system of statement 18, wherein determining SER is calculated at least with the source pulse, a resonance frequency and a casing thickness are firstly derived from the acoustic waveforms, a resonance window of the acoustic waveforms, and amplitude spectrum of the source pulse.
Statement 20. The system of statements 13-19, wherein the information handling system is further configured to determine one or more attributes of the synthetic waveforms.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any comprised range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

1. A method comprising:
disposing an acoustic logging tool into a wellbore, wherein the acoustic logging tool comprises a P-E transceiver;
transmitting one or more acoustic waves from the acoustic logging tool with the P-E transceiver;
recording an acoustic waveform that is a superimposition of first reflection from inner surface of casing and/or subsequent reverberations from the casing with the P-E transceiver;
creating synthetic waveforms from source pulse and a testing parameter configuration;
identifying one or more model parameters of the wellbore; and
deriving a predicted impedance from at least the one or more model parameters of the wellbore and the acoustic waveform.

2. The method of claim 1, further comprising extracting a source pulse according to the model parameters.

3. The method of claim 2, wherein extracting the source pulse incorporates determining pulse excitation by identifying captured waveforms with the least amount of energy in a time window associated with casing reverberations.

4. The method of claim 3, wherein the least amount of energy is calculated as a summation of a reverberations portion of the pulse excitation.

5. The method of claim 2, further comprising determining one or more attributes of measured waveforms.

6. The method of claim 5, wherein the one or more attributes comprise a sum of absolute amplitude of a section in resonance (Rsum), and/or a spectral energy ratio (SER).

7. The method of claim 6, wherein determining SER is calculated at least with the source pulse, a resonance frequency and a casing thickness are firstly derived from the acoustic waveforms, a resonance window of the acoustic waveforms, and amplitude spectrum of the source pulse.

8. The method of claim 1, further comprising determining one or more attributes of the synthetic waveforms.

9. The method of claim 8, wherein determining one or more attributes of the synthetic waveform comprises at least calculating reflection coefficient between fluid and casing interface, with:
$${R}_{1} = \frac{{Z}_{s} - {Z}_{m}}{{Z}_{s} + {Z}_{m}}$$
where R₁ is the reflection coefficient between fluid and casing interface, Zₛ is the acoustic impedance of casing and Zₘ is the acoustic impedance of fluid, and scaling reverberation with:
$${A}_{{r}_{scaled}} = {A}_{r} \cdot {S}_{1}$$
where Aᵣ is an amplitude of initial reverberations, Aᵣ_{_{scaled}} is a reverberations amplitude, S₁ is a scaling factor which may either be established from experimental observation or numerical simulations.

10. The method of claim 8, further comprising correcting the one or more attributes of the a superimposition of first reflection from inner surface of casing and/or subsequent reverberations from the casing.

11. The method of claim 10, wherein correcting the one or more attributes of a superimposition of first reflection from inner surface of casing and/or subsequent reverberations from the casing comprises a standoff correction, a mud attenuation correction, and/or a casing curvature correction to form corrected attributes.

12. The method of claim 11, further comprising computing initial impedance with the corrected attributes from measured waveform and attributes from synthetic waveforms.

13. A system comprising:
an acoustic logging tool disposed in a wellbore, wherein the acoustic logging tool comprises a P-E transceiver configured to:
transmitting one or more acoustic waves from the acoustic logging tool with the P-E transceiver; and
recording an acoustic waveform that is a superimposition of first reflection from inner surface of casing and/or subsequent reverberations from the casing with the P-E transceiver;
an information handling system configured to:
create synthetic waveforms from source pulse and a testing parameter configuration;
identify one or more model parameters of the wellbore; and
derive a predicted impedance from at least the one or more model parameters of the wellbore and the acoustic waveform.

14. The system of claim 13, wherein the information handling system is further configured to extract a source pulse according to the model parameters.

15. The system of claim 14, wherein extracting the source pulse incorporates determining pulse excitation by identifying captured waveforms with the least amount of energy in a time window associated with casing reverberations.

16. The system of claim 15, wherein the least amount of energy is calculated as a summation of a reverberations portion of the pulse excitation.

17. The system of claim 14, wherein the information handling system is further configured to determine one or more attributes of measured waveforms.

18. The system of claim 17, wherein the one or more attributes comprise a sum of absolute amplitude of a section in resonance (Rsum), and/or a spectral energy ratio (SER).

19. The system of claim 18, wherein determining SER is calculated at least with the source pulse, a resonance frequency and a casing thickness are firstly derived from the acoustic waveforms, a resonance window of the acoustic waveforms, and amplitude spectrum of the source pulse.

20. The system of claim 13, wherein the information handling system is further configured to determine one or more attributes of the synthetic waveforms.
